(19) United States
(12) Patent Application Publication
(10) Pub. No.: US 2022/0361456 A1
(43) Pub. Date: Nov. 17, 2022

(54) INTELLIGENT PET CALLING DEVICE

(71) Applicant: Huizhou du du Pet Products Co. LTD, Huizhou (CN)

(72) Inventors: Xianqiang Zhang, Xiangtan (CN); Zuohua Xiong, Huizhou (CN)

(73) Assignee: Huizhou du du Pet Products Co. LTD, Huizhou (CN)

(21) Appl. No.: 17/876,581

(22) Filed: Jul. 29, 2022

(51) Int. Cl. A01K 29/00; A01K 15/02; A01K 11/00; A01K 27/00; H04W 4/029; H04W 4/02; H04W 4/80; G06V 40/10; H04N 5/33

(52) U.S. Cl. CPC A01K 29/005; A01K 15/021; A01K 11/008; A01K 27/001; H04W 4/029; H04W 4/023; H04W 4/80; G06V 40/10; H04N 5/33

(57) ABSTRACT

The present disclosure discloses an intelligent pet calling device, including a collar detachably connected to the body or head of a pet, and a functional box detachably arranged on the collar; a wireless connection module and a voice device are arranged in the functional box; the functional box also includes a shell assembly, a control board, a battery, a button and a charging interface; the shell assembly is a hollow cavity; the control board, the voice device and the battery are respectively fixedly arranged in the shell assembly; the battery supplies electric energy to the control board and the voice device; the button and the charging interface are respectively arranged on the control box and penetrate through the shell assembly; the functional box also includes a heart rate monitoring device; and the functional box further includes a camera.

### TECHNICAL FIELD

The present disclosure relates to the technical field of pet supplies, specifically to an intelligent pet calling device.

### BACKGROUND

A pet calling device is a pet product used for training, recalling and preventing loss of pets such as cats and dogs. The pet calling device in the prior art generally only has a voice input function and a voice playback function. Pets receive an input voice training command through this pet calling device. For example, when receiving a return command, a pet walking far away goes back, and pet loss is avoided. However, a use distance of the pet calling device is restrained by a signal connection distance between a control circuit and a transmitting control circuit. After a pet is out of a signal range, the voice training command cannot be transmitted. In addition, when a pet strays into a strange environment and is in a state of panic, the execution of the voice training command may not be guaranteed. In this process, if an owner cannot notice a pet being missing, the owner will miss the important time period for finding the pet, so that anti-loss effect is poor. Therefore, there is an urgent need for a pet calling device that can timely remind pets of being lost.

### SUMMARY

One of the purposes of the present disclosure is to provide an intelligent pet calling device to solve the above-mentioned problems.

An intelligent pet calling device of the present disclosure can be implemented by the following technical solutions:

An intelligent pet calling device of the present disclosure includes a collar detachably connected to the body or head of a pet, and a functional box detachably arranged on the collar. A wireless connection module and a voice device are arranged in the functional box; the functional box further includes a shell assembly, a control board, a battery, a button and a charging interface; the shell assembly is a hollow cavity; the control board, the voice device and the battery are respectively fixedly arranged in the shell assembly; the control board is respectively electrically connected to the voice device, the battery, the button and the charging interface and correspondingly controls the same; the battery supplies electric energy to the control board and the voice device; the button and the charging interface are respectively arranged on the control box and penetrate through the shell assembly; the button controls opening and closing of the functional box and carries out a voice recording operation; the battery is charged through the charging interface; the voice device plays back a voice to call a pet; the functional box further comprises a heart rate monitoring device; the heart rate monitoring device is arranged in the shell assembly and is next to the body of the pet to monitor a heart rate change of the pet in real time; the heart rate monitoring device is electrically connected to the control board; the functional box further includes a camera; the camera is arranged on the control board, penetrates through the shell assembly, and is electrically connected to the control board; and the camera takes pictures of an environment around a pet.

In one implementation, the collar includes a collar belt, connecting buckles and an adjustment buckle; the collar belt is detachably connected to the body or head of the pet; the connecting buckles are respectively arranged at two ends of the collar belt; the collar is fixed on the body or head of the pet through the connecting buckles; and the adjustment buckle is arranged on the collar belt and is able to adjust a length of the collar belt.

In one implementation, the collar includes a collar belt and connecting buckles; and the connecting buckles are able to adjust a length of the collar belt to fix the collar on the body or head of the pet.

In one implementation, a luminous belt is arranged on an outer surface of the collar belt.

In one implementation, the intelligent pet calling device further includes a miniature positioning base station wirelessly connected to the functional box through the wireless connection module; a wireless receiving module and an alarm device are arranged in the miniature positioning base station; the wireless receiving module can receive a signal sent by the functional box within a certain distance; and when a distance between the miniature positioning base station and the functional box exceeds a preset value, the alarm device will sound an alarm to a pet owner.

In one implementation, the wireless connection module includes various of a Bluetooth wireless connection module, an infrared wireless connection module, a 4G wireless connection module, a 5G wireless connection module, and a WIFI wireless connection module.

In one implementation, the camera adopts an infrared high-definition camera, which is convenient for taking clear pictures in dark places.

In one implementation, the shell assembly includes a main shell and a cover plate; the main shell is a hollow cavity; the cover plate is arranged above the main shell; and the main shell and the cover plate are tightly connected with each other through a fastener structure or a screw structure.

In one implementation, two ends of the main shell are symmetrically provided with connecting holes; and the collar is respectively connected to the two connecting holes to fix the functional box.

In one implementation, a microphone, a memory, a wireless connection module, a positioning chip and an indicator lamp are arranged on the control board; the microphone makes a voice record, so that the pet owner calls the pet with voice; the memory stores a calling voice; the wireless connection module is wirelessly connected to the miniature positioning base station and a mobile control terminal respectively; the positioning chip is convenient for accurately positioning the pet; and the indicator lamp indicates the power of the battery.

In one implementation, the battery adopts a polymer lithium ion battery; the charging interface adopts a micro USB interface, a Type C interface, a pogopin interface, a Lightning interface or a charging electrode.

In one implementation, when the charging interface adopts the charging electrode, magnets are respectively arranged on side edges of the two charging interfaces; and the two magnets have opposite polarities, which are convenient for abutting for a charging head.

In one implementation, the button includes an on/off button and a record button.

In one implementation, the intelligent pet calling device further includes a colorful lamp strip; and the colorful lamp strip is arranged on a front surface of the shell assembly and is electrically connected to the control board to display light in different colors.

Compared with the prior art, the intelligent pet calling device of the present disclosure has the beneficial effects as follows:

The intelligent pet calling device of the present disclosure plays back a voice through the voice device to call a pet; the heart rate monitoring device next to the body of the pet monitors the heart rate change of the pet in real time and estimates a health state of the pet; the camera takes pictures of the environment surrounding the pet to prevent missing of the pet; the battery charges all the components and stores power for the components; pet calling, health assessment, anti-loss and charging functions are integrated; meanwhile, by means of wireless connection between the external miniature positioning base station and the control board, when the pet moves to make a distance between the functional box and the miniature positioning base station exceed a signal connection distance, the miniature positioning base station is disconnected from the control board; at this time, the control board is controlled to send a remind signal to the mobile control terminal to remind the pet owner that the pet has been far away from the maximum distance between the miniature positioning base station and the functional box; and the pet owner acquires information about pet loss in time and searches for the pet as early as possible.

### BRIEF DESCRIPTION OF THE DRAWINGS

FIG. 1 is a schematic diagram of a three-dimensional structure of an intelligent pet calling device of the present disclosure;

FIG. 2 is a schematic diagram of a three-dimensional structure of a main body of the intelligent pet calling device of the present disclosure as shown in FIG. 1;

FIG. 3 is a schematic diagram of a three-dimensional structure of a functional box of the intelligent pet calling device of the present disclosure as shown in FIG. 1;

FIG. 4 is a schematic exploded diagram of the functional box of the intelligent pet calling device of the present disclosure as shown in FIG. 3;

FIG. 5 is a schematic exploded diagram of the functional box of the intelligent pet calling device of the present disclosure as shown in FIG. 3 from another angle.

### DETAILED DESCRIPTION OF THE EMBODIMENTS

The technical solutions in the embodiments of the present disclosure will be described clearly and completely below in combination with the accompanying drawings of the embodiments of the present disclosure. Apparently, the described embodiments are only part of the embodiments of the present disclosure, not all embodiments.

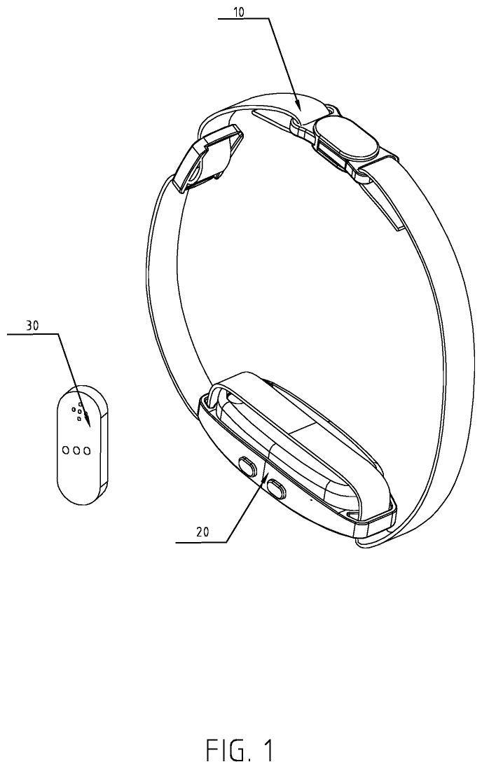

Referring to FIG. 1, an intelligent pet calling device of the present disclosure mainly includes a collar 10, a functional box 20 and a miniature positioning base station 30. The collar 10 is detachably connected to the body or head of a pet; the functional box 20 is detachably arranged on the collar 10. A wireless connection module and a voice device 23 are arranged in the functional box. The wireless connection module can be wirelessly connected to the miniature positioning base station 30; the voice device 23 plays back a voice to call a pet; a wireless receiving module and an alarm device are arranged in the miniature positioning base station 30; the wireless receiving module can receive a signal sent by the functional box 20 within a certain distance; and when a distance between the miniature positioning base station 30 and the functional box 20 exceeds a preset value, the alarm device will sound an alarm to a pet owner.

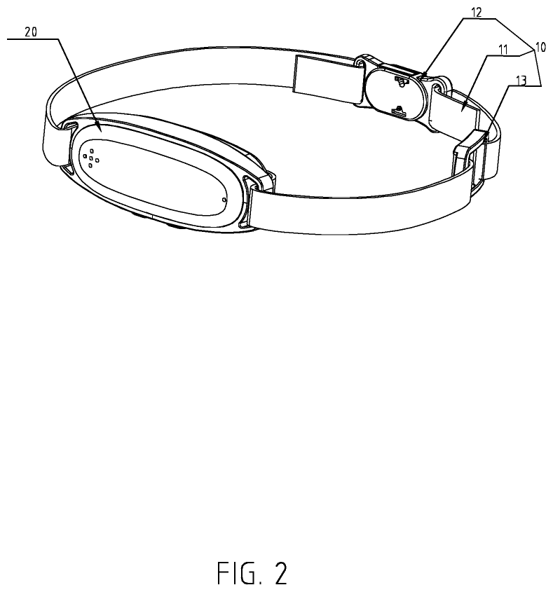

Referring to FIG. 1 and FIG. 2, in this embodiment, the collar 10 includes a collar belt 11, connecting buckles 12 and an adjustment buckle 13; the collar belt 10 11 is detachably connected to the body or head of the pet; the connecting buckles 12 are respectively arranged at two ends of the collar belt 1011; the collar 10 is fixed on the body or head of the pet through the connecting buckles 12; and the adjustment buckle 13 is arranged on the collar belt 11 and can adjust a length of the collar belt 11. In some embodiments, the collar 10 only includes a collar belt 11 and connecting buckles 12; and the connecting buckles 12 can adjust a length of the collar belt 11 to fix the collar 10 on the body or head of the pet. In some other embodiments, a luminous belt is arranged on an outer surface of the collar belt 11, so that it is convenient to quickly find the location of a pet in a dark environment.

Referring to FIG. 1 to FIG. 5, in this embodiment, the functional box 20 includes a shell assembly 21, a control board 22, a voice device 23, a camera 24, a heart rate monitoring device 25, a battery 26, a button 27, a charging interface 28 and a colorful lamp strip 29; the shell assembly 21 is a hollow cavity; the control board 22, the voice device 23, the heart rate monitoring device 25 and the battery 26 are respectively fixedly arranged in the shell assembly 21; the control board 22 is electrically connected to the voice device 23, the camera 24, the heart rate monitoring device 25, the battery 26, the button 27, the charging interface 28 and the colorful lamp strip 29 respectively, and correspondingly controls the voice device 23, the camera 24, the heart rate monitoring device 25, the battery 26, the button 27, the charging interface 28 and the colorful lamp strip 29; the voice device 23 plays back a voice to call a pet; the heart rate monitoring device 25 monitors a heart rate change of a pet in real time; the battery 26 supplies electric energy to the control board 22, the voice device 23, the camera 24, the heart rate monitoring device 25 and the colorful lamp strip 29; the camera 24, the button 27 and the charging interface 28 are respectively arranged on the control board 22 and penetrate through the shell assembly 21; the camera 24 takes pictures of a surrounding environment of a pet in real time; the button 27 controls opening and closing of the functional box 20 and carries out a voice recording operation; the battery 26 is charged through the charging interface 28; the colorful lamp strip 29 is arranged on a front surface of the shell assembly 21; and light in different colors can be controlled to be flickering through a control program or an applet on the mobile control terminal, so that the pet owner can quickly find the pet according to the light emitted by the colorful lamp strip 29.

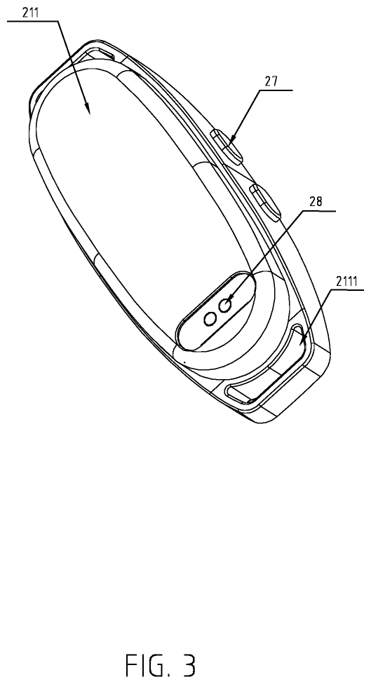

Referring to FIG. 3 to FIG. 5, in this embodiment, the shell assembly 21 includes a main shell 211 and a cover plate 212; the main shell 211 is a hollow cavity; the cover plate 212 is arranged above the main shell 211; and the main shell and the cover plate are tightly connected with each other through a fastener structure or a screw structure. In this embodiment, two ends of the main shell 211 are symmetrically provided with connecting holes 2111; and the collar 10 is respectively connected to the two connecting holes 2111 to fix the functional box 20. A button hole 2112 and a charging hole 2113 are formed in a side edge or a button cover of the main shell 211. The numbers and positions of the button hole 2112 and the charging hole 2113 respectively correspond to the numbers and positions of the button 27 and the charging interface 28. In this embodiment, a fixing cavity 2121 is arranged on an inner side of the cover plate 212; the voice device 23 is fixedly arranged in the fixing cavity 2121; a position of the cover plate 212 corresponding to the voice device 23 is provided with a plurality of sound amplification holes; and a sound from the voice device 23 is amplified through the plurality of sound amplification holes.

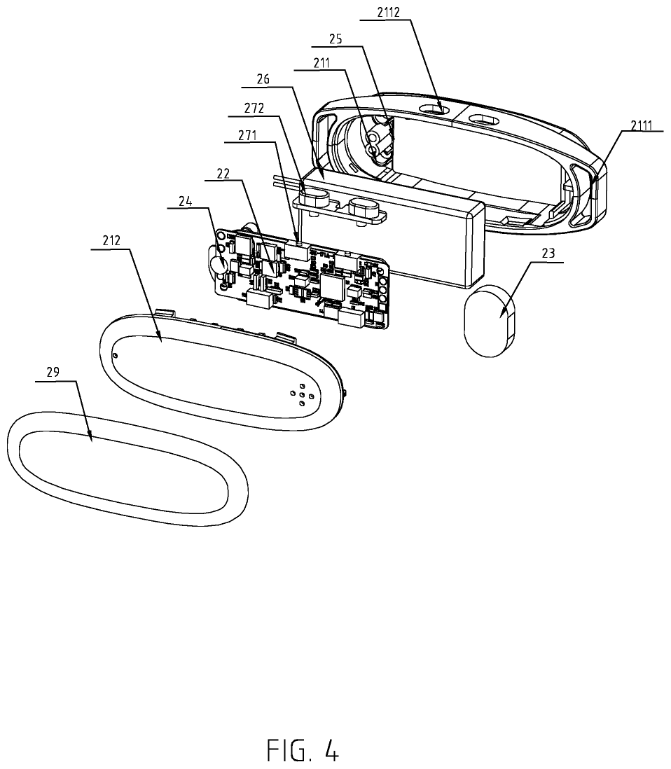

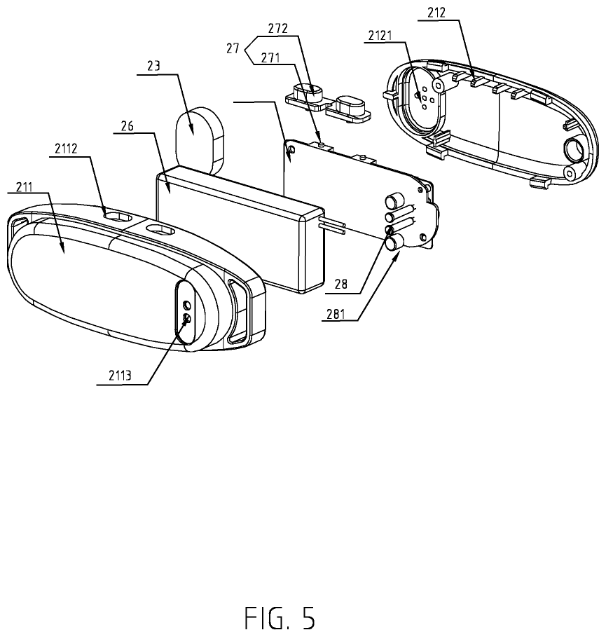

Referring to FIG. 4 and FIG. 5, a microphone, a memory, a wireless connection module, a positioning chip and an indicator lamp are arranged on the control board 22; the microphone makes a voice record, so that the pet owner calls the pet with voice; the memory stores a calling voice; the wireless connection module is wirelessly connected to the miniature positioning base station 30 and a mobile control terminal respectively; the wireless connection module includes various of a Bluetooth wireless connection module, an infrared wireless connection module, a 4G wireless connection module, a 5G wireless connection module, and a WIFI wireless connection module; and the mobile control terminal may be a mobile phone or a flat computer on which a control program or an applet is installed. When the pet owner is near the pet, the pet owner carries the miniature positioning base station 30; when a distance between the pet and the owner exceeds the maximum connection distance between the miniature positioning base station 30 and the control board 22, the control board 22 sends a message to the mobile control terminal that the pet has been far away from the pet owner, thus avoiding pet loss caused by distraction of the pet owner; meanwhile, the miniature positioning base station 30 will sound an alarm to inform the pet owner to search for the pet; when the pet owner goes out, the miniature positioning base station 30 can be placed in the house; when the pet leaves the house from an open door or window, the control board 22 can send remind information to the mobile control terminal, so that the pet owner can timely find that the pet leaves the house when there is no one in the house; and the pet owner comes back and searches for the pet as early as possible. After the pet owner receives signal disconnection of the control board 22 from the miniature positioning base station 30, the pet owner wirelessly connects the mobile control terminal to the control board 22 through the wireless connection module at this time, and can issue a signal to the control board 22 through the control program or applet in the mobile control terminal; the control board 22 controls the voice device 23 to play back a pre-recorded voice training command to command the pet to come back; the positioning chip is convenient for accurately positioning the pet; when the pet is lost, the pet owner can search for the pet according to the location positioned by the positioning chip; and the indicator lamp can indicate the power of the battery 26.

Referring to FIG. 4 and FIG. 5, in this embodiment, the voice device 23 adopts a horn. In this embodiment, the camera 24 adopts an infrared high-definition camera, so that it is convenient for taking clear pictures in dark places. When the pet is stimulated by an external environment, the heart rate of a pet, particularly a cat, increases; when the cat is panic, namely, when the cat is stressed, the cat may be dead in a severe case; when the heart rate monitoring device 25 monitors a rapid increase of the heart rate of the pet in real time, the control board 22 controls the camera 24 to be turned on at this time, and the camera 24 acquires images of an environment surrounding the pet in real time; and the images are sent to a mobile phone of the pet owner via the control board 22, so that the pet owner can determine the environment and location where the pet is located in combination with the images. In order to avoid consumption of the power of the battery 26 since the camera 24 is turned on for a long time, a turn-on signal of the camera 24 is triggered by means of setting a heart rate threshold monitored by the heart rate monitoring device 25. In this embodiment, the heart rate monitoring device 25 is arranged on an inner side of the main shell 211 and is next to the body of the pet to monitor the heart rate change of the pet in real time, and data is sent to the control program of the mobile phone to analyze the health state of the pet via the program. In this embodiment, the battery 26 adopts a polymer lithium ion battery.

Referring to FIG. 3 to FIG. 5, in this embodiment, there are two buttons 27, including an on/off button and a record button; the on/off button is used for controlling the functional box 20 to be turned on and turned off; when the functional box is in an off state, a long press of 2-5 s can turn on the functional box; when the functional box is in an on state, a long press of 2-5 s can turn off the functional box; a short press on the record button plays back a recorded voice, and a long press of 2-5 s on the record button records audios; the button 27 includes a button main body 271 and a button shell 272; the button main body 271 is fixedly arranged on the control board 22 and penetrates through the shell assembly 21; and the button shell 272 is arranged on the button main body 271 to protect the button main body 271. Specifically, a material of the button shell 272 is silica gel. In some embodiments, the button 27 may also be a touch button.

Referring to FIG. 3 and FIG. 5, the charging interface 28 can adopt a Micro USB interface, a Type C interface, a Lightning interface or a charging electrode. In this embodiment, in order to improve the waterproofing performance of the functional box 20, the charging interface 28 adopts a charging electrode. Magnets 281 are respectively arranged on side edges of the two charging interfaces 28; and the two magnets 281 have opposite polarities, which are convenient for abutting to a charging head and preventing a failure caused by mis-operations.

The technical features of the embodiments described above can be arbitrarily combined. In order to make the description concise, all possible combinations of various technical features in the above embodiments are not completely described. However, the combinations of these technical features should be considered as the scope described in the present specification as long as there is no contradiction in them.

What is claimed is:

1. An intelligent pet calling device, comprising a collar detachably connected to the body or head of a pet, and a functional box detachably arranged on the collar, wherein a wireless connection module and a voice device are arranged in the functional box; the functional box further comprises a shell assembly, a control board, a battery, a button and a charging interface; the shell assembly is a hollow cavity; the control board, the voice device and the battery are respectively fixedly arranged in the shell assembly; the control board is respectively electrically connected to the voice device, the battery, the button and the charging interface and correspondingly controls the same; the battery supplies electric energy to the control board and the voice device; the button and the charging interface are respectively arranged on the control box and penetrate through the shell assembly; the button controls opening and closing of the functional box and carries out a voice recording operation;
the battery is charged through the charging interface; the voice device plays back a voice to call a pet;
the functional box further comprises a heart rate monitoring device; the heart rate monitoring device is arranged in the shell assembly and is next to the body of the pet to monitor a heart rate change of the pet in real time; the heart rate monitoring device is electrically connected to the control board; the functional box further includes a camera; the camera is arranged on the control board, penetrates through the shell assembly, and is electrically connected to the control board; and the camera takes pictures of an environment around a pet.

2. The intelligent pet calling device according to claim 1, wherein the collar comprises a collar belt, connecting buckles and an adjustment buckle; the collar belt is detachably connected to the body or head of the pet; the connecting buckles are respectively arranged at two ends of the collar belt; the collar is fixed on the body or head of the pet through the connecting buckles; and the adjustment buckle is arranged on the collar belt and is able to adjust a length of the collar belt.

3. The intelligent pet calling device according to claim 1, wherein the collar comprises a collar belt and connecting buckles; and the connecting buckles are able to adjust a length of the collar belt to fix the collar on the body or head of the pet.

4. The intelligent pet calling device according to claim 2, wherein a luminous belt is arranged on an outer surface of the collar belt.

5. The intelligent pet calling device according to claim 1, comprising a miniature positioning base station wirelessly connected to the functional box through the wireless connection module, wherein a wireless receiving module and an alarm device are arranged in the miniature positioning base station; the wireless receiving module is able to receive a signal sent by the functional box within a certain distance; and when a distance between the miniature positioning base station and the functional box exceeds a preset value, the alarm device sounds an alarm to a pet owner.

6. The intelligent pet calling device according to claim 5, wherein the wireless connection module comprises various of a Bluetooth wireless connection module, an infrared wireless connection module, a 4G wireless connection module, a 5G wireless connection module, and a WIFI wireless connection module.

7. The intelligent pet calling device according to claim 1, wherein the camera adopts an infrared high-definition camera, which is convenient for taking clear pictures in dark places.

8. The intelligent pet calling device according to claim 1, wherein the shell assembly comprises a main shell and a cover plate; the main shell is a hollow cavity; the cover plate is arranged above the main shell; and the main shell and the cover plate are tightly connected with each other through a fastener structure or a screw structure.

9. The intelligent pet calling device according to claim 8, wherein two ends of the main shell are symmetrically provided with connecting holes; and the collar is respectively connected to the two connecting holes to fix the functional box.

10. The intelligent pet calling device according to claim 1, wherein a microphone, a memory, a wireless connection module, a positioning chip and an indicator lamp are arranged on the control board; the microphone makes a voice record, so that the pet owner calls the pet with voice; the memory stores a calling voice; the wireless connection module is wirelessly connected to the miniature positioning base station and a mobile control terminal respectively; the positioning chip is convenient for accurately positioning the pet; and the indicator lamp indicates the power of the battery.

11. The intelligent pet calling device according to claim 1, wherein the battery adopts a polymer lithium ion battery; the charging interface adopts a Micro USB interface, a Type C interface, a pogopin interface, a Lightning interface or a charging electrode.

12. The intelligent pet calling device according to claim 11, wherein when the charging interface adopts the charging electrode, magnets are respectively arranged on side edges of the two charging interfaces; and the two magnets have opposite polarities, which are convenient for abutting to a charging head.

13. The intelligent pet calling device according to claim 1, wherein the button comprises an on/off button and a record button.

14. The intelligent pet calling device according to claim 1, further comprising a colorful lamp strip; and the colorful lamp strip is arranged on a front surface of the shell assembly and is electrically connected to the control board to display light in different colors.
